(19) United States
(12) Patent Application Publication
(10) Pub. No.: US 2017/0054368 A1
(43) Pub. Date: Feb. 23, 2017

(54) Multi-Topology Power Converter Controller

(71) Applicant: Infineon Technologies Austria AG, Villach (AT)

(72) Inventor: Darryl Tschirhart, Torrance, CA (US)

(21) Appl. No.: 14/830,430

(22) Filed: Aug. 19, 2015

(51) Int. Cl. H02M 3/158; G06F 1/32; G06F 1/26

(52) U.S. Cl. CPC H02M 3/158; G06F 1/26; G06F 1/3296

(57) ABSTRACT

A DC/DC voltage conversion system includes a first voltage converter operable to convert a first DC voltage rail to a second DC voltage rail different than the first DC voltage rail, and a second voltage converter operable to convert the second DC voltage rail to a third DC voltage rail lower than the second DC voltage rail. The second voltage converter is a multiphase converter having a plurality of power stages, each power stage providing a phase of the multiphase converter and configured to conduct current. The DC/DC voltage conversion system further comprises a single controller having a first control loop for controlling the first voltage converter and a second control loop for controlling the second voltage converter. The second control loop is a multiphase control loop configured to enable multiphase operation of the second voltage converter.

### TECHNICAL FIELD

The present application relates to intermediate DC/DC voltage bus converters, in particular control of intermediate DC/DC voltage bus converters.

### BACKGROUND

To save power in datacenters and other data-intensive applications, a typical 12V DC distribution bus can be replaced by a higher voltage bus e.g. typically 48V nominal. This higher distribution voltage is stepped down on the motherboard in one or more stages to the low DC voltage required by the CPU (central processing unit), memory, and other electronic components included in the system such as memory, graphics logic, I/O (input/output), etc. For example, a DC/DC converter conventionally generates an intermediate bus voltage that is fed to all lower-voltage converter stages. The intermediate bus is typically between 5-12V and can therefore use existing infrastructure to be highly scalable. In another example, the CPU has a dedicated converter (e.g. 48V to 1V) that can be a single conversion stage, or two converter stages in series to achieve the step down. The other voltage rails (e.g. memory, graphics logic, etc.) are fed from a common intermediate bus. In still another example, all voltage rails are fed directly from the 48V distribution bus. In this case scalability is limited, and the use of existing infrastructure is not an option. Other architectures employ multiple intermediate bus voltages for feeding different voltage rails, using direct conversion for the CPU and some other voltage rails with the intermediate bus powering the rest, or some combination thereof.

In each case, a controller is required for each of the DC/DC converters. In the case of the low voltage rails, a buck converter is the typical topology. Multi-loop controllers can be used to save cost, where one loop powers the CPU and another loop(s) provides control to one or more auxiliary rail(s). With the numerous possible topologies available for the intermediate bus converter, a separate controller is typically used for that specific topology.

In the analog domain, controllers are made for topologies with similar requirements. For example, forward and flyback converters have single ground-referenced switches on the transformer primary. Conventional digital controllers are capable of implementing a wide array of converter topologies and are capable of multiple communication protocols. However, conventional digital controllers lack the ability to implement multi-phase buck converters for voltage regulation applications and also lack standard CPU serial communication protocols.

### SUMMARY

According to an embodiment of a DC/DC voltage conversion system, the DC/DC voltage conversion system comprises a first voltage converter operable to convert a first DC voltage rail to a second DC voltage rail different than the first DC voltage rail and a second voltage converter operable to convert the second DC voltage rail to a third DC voltage rail lower than the second DC voltage rail. The second voltage converter is a multiphase converter comprising a plurality of power stages, each power stage providing a phase of the multiphase converter and configured to conduct current. The DC/DC voltage conversion system further comprises a controller having a first control loop for controlling the first voltage converter and a second control loop for controlling the second voltage converter. The second control loop is a multiphase control loop configured to enable multiphase operation of the second voltage converter.

According to an embodiment of a server, the server comprises a central processing unit (CPU), memory coupled to the CPU, a DC/DC voltage conversion system for powering the CPU and the memory, and a DC voltage distribution bus coupled to the DC/DC voltage conversion system. The DC/DC voltage conversion system comprises a first voltage converter operable to convert a first DC voltage rail provided by the DC voltage distribution bus to a second DC voltage rail different than the first DC voltage rail and a second voltage converter operable to convert the second DC voltage rail to a third DC voltage rail provided by the DC voltage distribution bus and which is lower than the second DC voltage rail. The second voltage converter is a multiphase voltage regulator comprising a plurality of power stages, each power stage providing a phase of the multiphase voltage regulator and configured to deliver current to the CPU. The DC/DC voltage converter also includes a controller comprising a first control loop for controlling the first voltage converter and a second control loop for controlling the second voltage converter. The second control loop is a multiphase control loop configured to enable multiphase operation of the second voltage converter.

Those skilled in the art will recognize additional features and advantages upon reading the following detailed description, and upon viewing the accompanying drawings.

### BRIEF DESCRIPTION OF THE FIGURES

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 illustrates a block diagram of an embodiment of a DC/DC voltage conversion system that includes a first voltage converter for converting a high bus voltage to an intermediate bus voltage, a second voltage converter for converting the intermediate bus voltage to a lower bus voltage, and a multi-loop controller for controlling both converters.

FIG. 2 illustrates a more detailed block diagram of the multi-loop controller and second voltage converter of the DC/DC voltage conversion system shown in FIG. 1.

FIG. 3 illustrates a block diagram of an embodiment of a server that includes a DC/DC voltage conversion system that includes a first voltage converter for converting a high bus voltage to an intermediate bus voltage, a second voltage converter for converting the intermediate bus voltage to a lower bus voltage, and a multi-loop controller for controlling both converters.

FIG. 4 illustrates a block diagram of another embodiment of a server that includes a DC/DC voltage conversion system that includes a first voltage converter for converting a high bus voltage to an intermediate bus voltage, a second voltage converter for converting the intermediate bus voltage to a lower bus voltage, and a multi-loop controller for controlling both converters.

FIG. 5 illustrates a block diagram of yet another embodiment of a server that includes a DC/DC voltage conversion system that includes a first voltage converter for converting a high bus voltage to an intermediate bus voltage, a second voltage converter for converting the intermediate bus voltage to a lower bus voltage, and a multi-loop controller for controlling both converters.

FIG. 6 illustrates a pinout diagram of an embodiment of a multi-loop controller for controlling two or more voltage converters of a DC/DC voltage conversion system.

FIG. 7 illustrates signal connections between the multi-loop controller shown in FIG. 6 and two voltage converters of a DC/DC voltage conversion system.

### DETAILED DESCRIPTION

Embodiments described herein relate to a DC/DC voltage conversion system that includes a first voltage converter for converting a high bus voltage to an intermediate bus voltage and a second voltage converter for converting the intermediate bus voltage to a lower bus voltage such as a voltage for supplying a CPU. The second voltage converter is a multiphase converter having a plurality of power stages. Each power stage provides a phase of the multiphase converter and conducts current. The DC/DC voltage conversion system also includes a controller having a first control loop for controlling the first voltage converter and a second control loop for controlling the second voltage converter. The second control loop is a multiphase control loop configured to enable multiphase operation of the second voltage converter. The first voltage converter also can be a multiphase converter. In this case, the first control loop of the controller also is a multiphase control loop configured to enable multiphase operation of the first voltage converter.

In general, the multi-loop controller is a digital controller which can implement multiple voltage rails of different topologies at different voltage and power levels on the same semiconductor die (chip). The same controller can be used for downstream voltage regulation (VR) and upstream intermediate bus (IB) conversion. By combining IBNR control, communication between a CPU and its voltage regulator can be easily monitored without requiring extra pins by the intermediate bus converter to promote enhanced power saving.

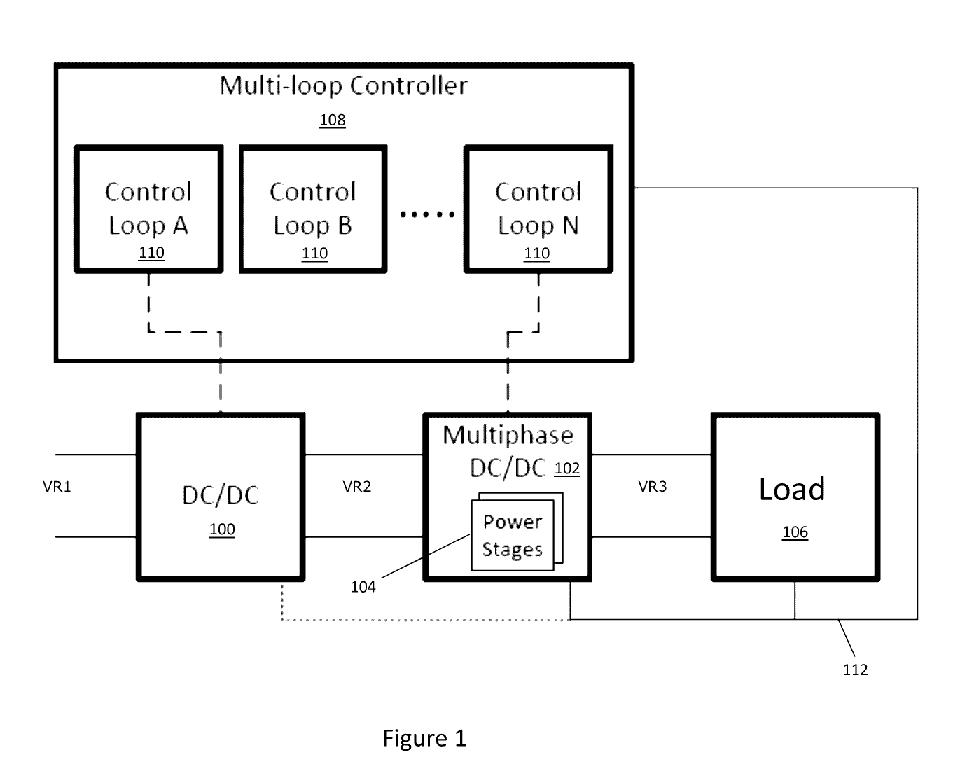

FIG. 1 illustrates an embodiment of the DC/DC voltage conversion system. The DC/DC voltage conversion system comprises a first voltage converter 100 for converting a first DC voltage rail (VR1) to a second DC voltage rail (VR2) different than the first DC voltage rail VR1. The level of the second DC voltage rail VR2 can be lower or higher than the first DC voltage rail VR1. For example, 48V is the nominal voltage for systems that can vary from 35-75V for VR1. So in one embodiment, VR1 is at 48V (but can be 35-75V) and VR2 is at 12V. In another embodiment, VR1 again is at 48V but the second rail VR2 can be 54V. In general, the second DC voltage rail VR2 is different than the first DC voltage rail VR1.

The DC/DC voltage conversion system further comprises a second voltage converter 102 operable for converting the second DC voltage rail VR2 to a third DC voltage rail (VR3) lower than the second DC voltage rail VR2. The second voltage converter 102 is a multiphase converter comprising a plurality of power stages 104 i.e. two or more power stages 104. Each power stage 104 provides a phase of the multiphase converter 102 and conducts current. In one embodiment, the load 106 is a CPU and the second voltage converter 102 is a multiphase voltage regulator such as a multiphase buck converter that delivers current to the CPU at the third DC voltage rail VR3.

The DC/DC voltage conversion system also comprises a controller 108 such as a microcontroller, microprocessor, ASIC (application-specific integrated-circuit), etc. for controlling the voltage converters 100, 102 of the DC/DC voltage conversion system. The controller 108 includes a plurality of control loops 110. A first one (‘Control Loop A’) of the control loops 110 is used to control the first voltage converter 100 and another one (‘Control Loop N’) of the control loops 110 is used to control the second voltage converter 102. The second voltage converter 102 is a multiphase converter as explained above. As such, its control loop 110 is a multiphase control loop configured to enable multiphase operation of the second voltage converter 102. For example, the multiphase control loop 110 can generate PWM (pulse width modulation) signals for controlling the power stages 104 of the multiphase converter 102. The controller 108 can phase shift the PWM signals applied to the phases (also commonly referred to as “channels”) of the multiphase converter 102 to realize several advantages over a single phase converter, such as lower current ripple on the input and output capacitors, faster transient response to load steps, improved power handling capabilities, and higher system efficiency.

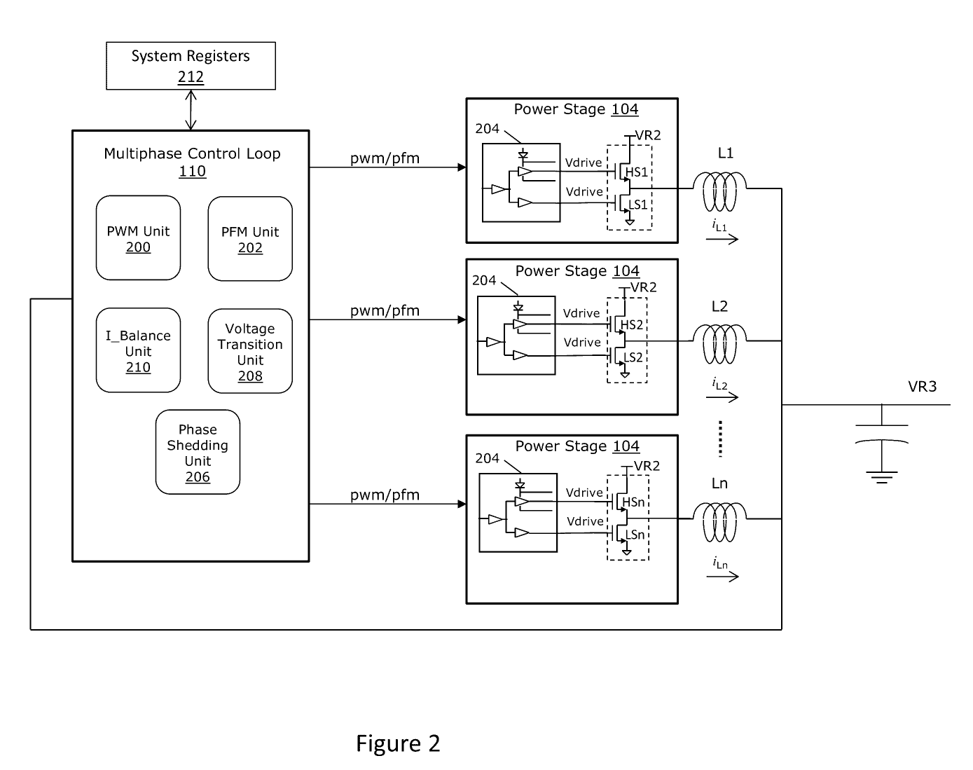

FIG. 2 illustrates an embodiment of the power stages 104 of the multiphase converter 102 and the multiphase control loop 110 of the controller 108 which controls switching of the power stages 104. Each power stage 104 is operable to deliver a phase current (i_{Ln}) through a separate inductor (Lₙ) to yield the third DC voltage rail VR3. In the case of a multiphase buck converter, the multiphase converter 102 produces a DC voltage rail VR3 less than VR2. In general, the multiphase converter 102 can be implemented using any standard isolated or non-isolated DC/DC converter architecture such as buck-boost converter, flyback converter, etc. such that the third DC voltage rail VR3 can be lower or higher than the second DC voltage rail VR2 provided by the first voltage converter 100.

Each power stage 104 of the multiphase buck converter shown in FIG. 2 has a high-side transistor (HSn) and a low-side transistor (LSn) for coupling to the third DC voltage rail VR3 through the corresponding inductor. The high-side transistor of each power stage 104 switchably connects the third DC voltage rail VR3 to the second DC voltage rail VR2, and the corresponding low-side transistor switchably connects the third DC voltage rail VR3 to ground at different periods. N power stages 104 are shown in FIG. 2. In general, the multiphase converter 102 can includes two or more power stages 104 (i.e. multi-phase where each power stage is one phase of the multi-phase regulator).

The multiphase control loop 110 regulates the third DC voltage rail VR3 delivered by the power stages 104 of the multiphase power converter 102, by adjusting the phase currents delivered by the power stages 104. Each power stage 104 is configured to output a maximum rated current at the third DC voltage rail VR3. The multiphase control loop 110 includes a pulse width modulator (PWM) unit 200 for switching each power stage 104 via a corresponding PWM control signal (pwm). The multiphase control loop 110 also includes a pulse frequency modulator (PFM) unit 202 for turning off all phases but one and switching that phase via a corresponding PFM (pfm) control signal e.g. during light-load operation at the load 106. Drivers 204 for the power stages 104 provide gate drive signals (Vdrive) to the gates of the corresponding high-side and low-side transistors in response to the PWM or PFM control signals provided by the multiphase control loop 110.

The multiphase control loop 110 can manage changes from one reference voltage to another at the load 106. The multiphase control loop 110 also can determine errors between the third DC voltage rail VR3 and the reference voltage, and convert the error voltage into a digital representation provided to the PWM and PFM units 200, 202 for modifying the switching cycle of each power stage 104 e.g. by adjusting the PWM duty cycle in PWM mode or switching frequency in PFM mode.

The amount of current delivered to the load 106 by the multiphase converter 102 corresponds to the operating set point of the multiphase converter 102, and the operating set point of the multiphase converter 102 in turn corresponds to the amount of current required by the load 106. The multiphase control loop 110 can change the operating set point of the multiphase converter 102 responsive to a command received from the load 106, such that the amount of current delivered to the load 106 is reduced. For example in the case of a CPU as the load 106, the CPU communicates with the multiphase converter 102 and optionally the first voltage converter 100 over a communication bus 112 as shown in FIG. 1 using a protocol for status, protection, and system optimization. Part of the optimization process includes the CPU instructing the multiphase converter 102 to change its operating set point so that the light-load efficiency of the multiphase converter 102 is increased when the CPU enters a low power state. This can include, but is not limited to: phase shedding where the multiphase converter 102 deactivates or sheds (drops) one or more previously active phases; dynamic reduction in the output voltage of the multiphase converter 102; transitioning the multiphase converter 102 from PWM to PFM (pulse frequency modulation) operation; etc.

For example, the multiphase control loop 110 used for controlling switching of the power stages 104 of the multiphase converter 102 can include a phase shedding unit 206 for implementing phase shedding to optimize efficiency over the load range. The phase shedding unit 206 turns on or off phases of the multiphase converter 102 so that only the phases required to power the load 106 are enabled. At the same time, the response of the multiphase control loop 110 can be tailored to achieve acceptable transient response over the load range. With phase shedding, efficiency improvements up to 30% or higher can be achieved. The multiphase control loop 110 also can include a voltage transition unit 208 for responding to a dynamic voltage transition at the load 106 from a first voltage to a second voltage.

The multiphase control loop 110 has a current balance (I_Balance) unit 210 for implementing phase current sensing and current balancing. One challenge in designing the multiphase converter 102 is ensuring that current is properly shared between phases. A significantly disproportionate amount of current in one phase will stress components and degrade their lifetime. The current balance (I_Balance) unit 210 can implement per-phase current sensing by monitoring the current through the power stage transistors, or by sensing the current through a shunt resistor placed in each phase. Another per-phase current sensing technique uses the DC resistance (DCR) of the inductors as a current sense element. The DCR approach makes use of an existing circuit element and provides good accuracy depending on the DCR tolerance. The current balance (I_Balance) unit 210 can implement still other types of standard per-phase current sensing techniques. In each case, the current balance (I_Balance) unit 210 ensures that each phase conducts approximately the same amount of current during multiphase operation of the multiphase voltage converter 102. The multiphase control loop 110 of the controller 108 can include other units (not shown for ease of illustration) for controlling operation of the multiphase converter 102.

The controller 108 also can include registers 212 for storing state information of the multiphase control loop 110. The control loop 110 which controls the first voltage converter 100 can utilize the state information for the multiphase control loop 110 in controlling the first voltage converter 100. For example, operation of the first voltage converter 100 can be modified based on the power state, current level, voltage level, switching mode (e.g. PWM or PFM), etc. of the multiphase control loop 110.

The controller 108 can include more than one multiphase control loop 110. For example, the first voltage converter 100 of the DC/DC voltage conversion system also can be a multiphase converter such as a multiphase buck converter having a plurality of power stages each of which provides a phase of the multiphase converter and conducts current. In this case, the controller 108 includes at least two multiphase control loops 110: a first multiphase control loop ('Control Loop A′) for enabling multiphase operation of the first voltage converter 100 and another multiphase control loop ('Control Loop N′) for enabling multiphase operation of the second voltage converter 102. The controller 108 can manage operation of both voltage converters 100, 102 based on communications received from the load 106.

Any standard communication protocol can be used by the load 106 to communicate commands to the controller 108 which cause one or both of the voltage converters 100, 102 to change their operating set points and correspondingly increase or lower their power output. For example through the SVID (serial VID) interface, the load 106 is a CPU that can dynamically control the output voltage, slew rates and power states of the second (multiphase) voltage converter 102, as well as monitor the multiphase converter 102 for telemetry purposes.

The DC/DC voltage conversion system can communicate with electronic components other than a CPU, e.g. including memory, graphics, I/O, and other electronic components. For example in a server environment, there can be as many as six voltage rails or more which are controlled by a CPU on a single board.

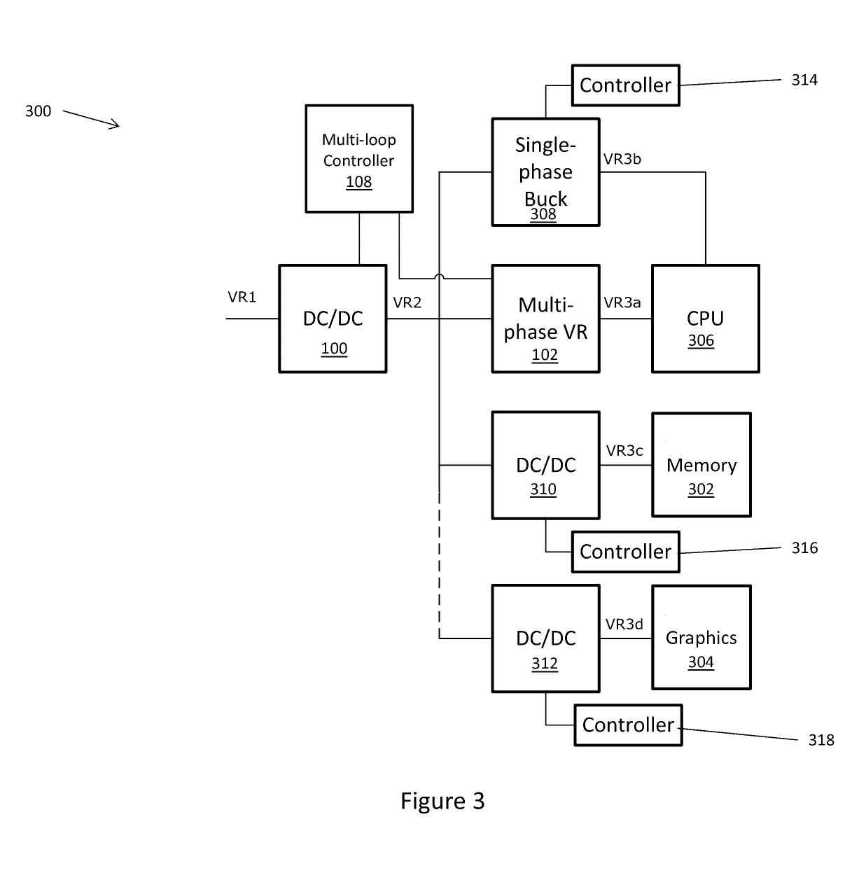

FIG. 3 illustrates an embodiment of a server 300 such as a datacenter server that includes a DC/DC voltage conversion system of the kind previously described herein for providing an intermediate voltage rail VR2 for powering all voltage rails VR3a, VR3b, VR3c, VR3d that supply electronic components 302, 304 in communication with a CPU 306. For example, the server 300 can include memory 302 such as volatile and/or nonvolatile memory and graphics logic 304 such as a graphics processor coupled to the CPU 306. The first voltage converter 100 of the DC/DC voltage conversion system converts a first DC voltage rail VR1 e.g. 48V to a second DC voltage rail VR2 different than the first DC voltage rail VR1 e.g. 12V. The second voltage converter 102 of the DC/DC voltage conversion system converts the second DC voltage rail VR2 to a third DC voltage rail VR3a lower than the second DC voltage rail e.g. 1V. The second voltage converter 102 is a multiphase voltage regulator according to this embodiment as previously described herein, and powers the CPU 306. According to one embodiment, the DC/DC voltage conversion system also includes a single-phase voltage regulator 308 such as a single-phase buck converter for powering the CPU 306 via a fourth DC voltage rail VR3b.

The DC/DC voltage conversion system also includes additional voltage converters 310, 312 for converting the second DC voltage rail VR2 to additional DC voltage rails VR3c, VR3d lower than the second DC voltage rail VR2 and different than the DC voltage rails VR3a, VR3b e.g. 5V, 3.3V, 0.9V, etc. Each additional voltage converter 310, 312 delivers current to an electronic component 302, 304 other than the CPU 306 at the corresponding additional DC voltage rail VR3c, VR3d, where the amount of current delivered to each of these electronic components 302, 304 corresponds to an operating set point of the corresponding voltage converter 310, 312. In general, the same controller 108 is configured to control operation of the first voltage converter 100 and the multiphase voltage regulator 102 of the DC/DC voltage conversion system according to this embodiment. Additional controllers 314, 316, 318 are provided for the other voltage converters 310, 312 included in the DC/DC voltage conversion system. A communication bus is provided between each voltage converter and its respective controller. The DC/DC converter 100 that transforms the VR1 bus voltage (e.g. 48V) to the VR2 bus voltage (e.g. 12V) is the IB converter, while the DC/DC converters 102, 308, 310, 312 that feed off of the VR2 rail are buck converters according to this embodiment.

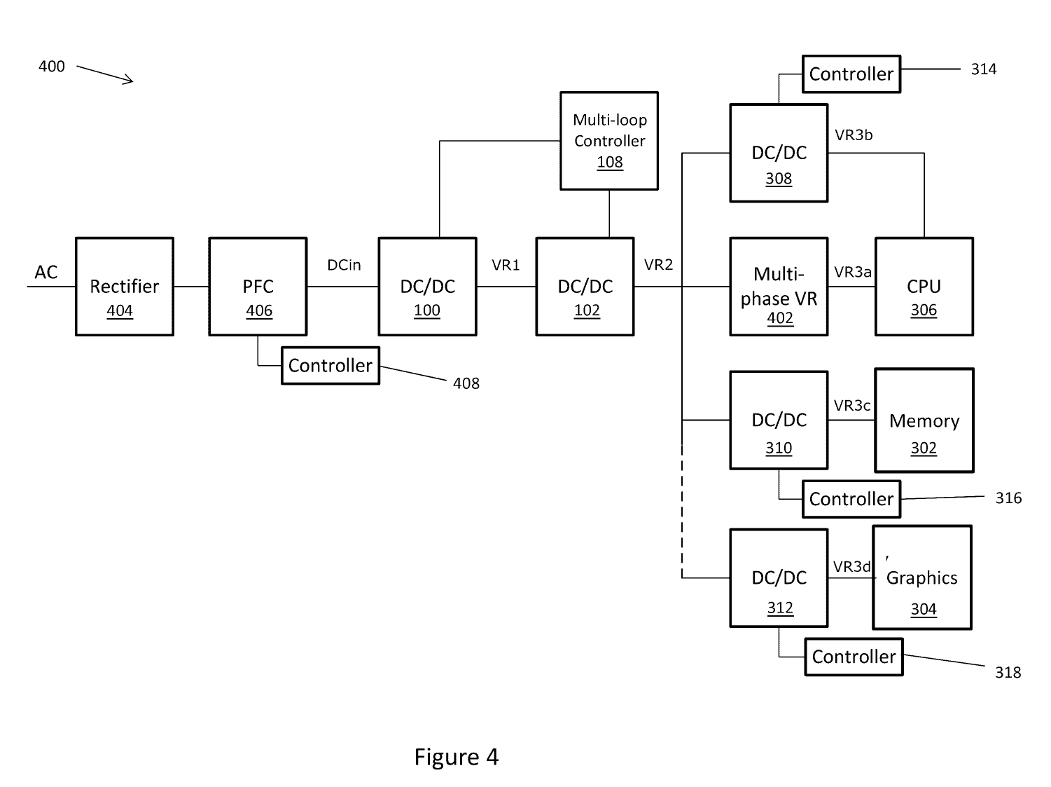

FIG. 4 illustrates another embodiment of a server 400 such as a datacenter server that includes a DC/DC voltage conversion system of the kind previously described herein for providing an intermediate voltage rail VR2 for powering all voltage rails VR3a, VR3b, VR3c, VR3d that supply electronic components in communication with the CPU 306. The embodiment shown in FIG. 4 is similar to the embodiment shown in FIG. 3. Different, however, two voltage converters 100, 102 exclusive of the CPU multiphase voltage regulator 402 are controlled by the same single controller 108. The design for this controller 108 is the same as in FIG. 3, however, the controller 108 in FIG. 4 is configured differently to support the different converter topologies. Also shown in FIG. 4 is front-end conversion circuitry which includes a rectifier 404 and a power factor correction (PFC) unit 406 and corresponding controller 408 for converting an AC voltage rail (AC) to a DC voltage distribution bus (DCin) coupled to the DC/DC voltage conversion system. The first voltage converter 100 of the DC/DC voltage conversion system converts the input DC voltage rail DCin provided by the DC voltage distribution bus e.g. at 400V to DC voltage rail VR1 e.g. at 48V and the second voltage converter 102 converts DC voltage rail VR1 to DC voltage rail VR2 e.g. at 12V. Communication between the controller 108 of the DC/DC voltage conversion system and the CPU 306 is not illustrated in FIGS. 3 and 4 for ease of illustration.

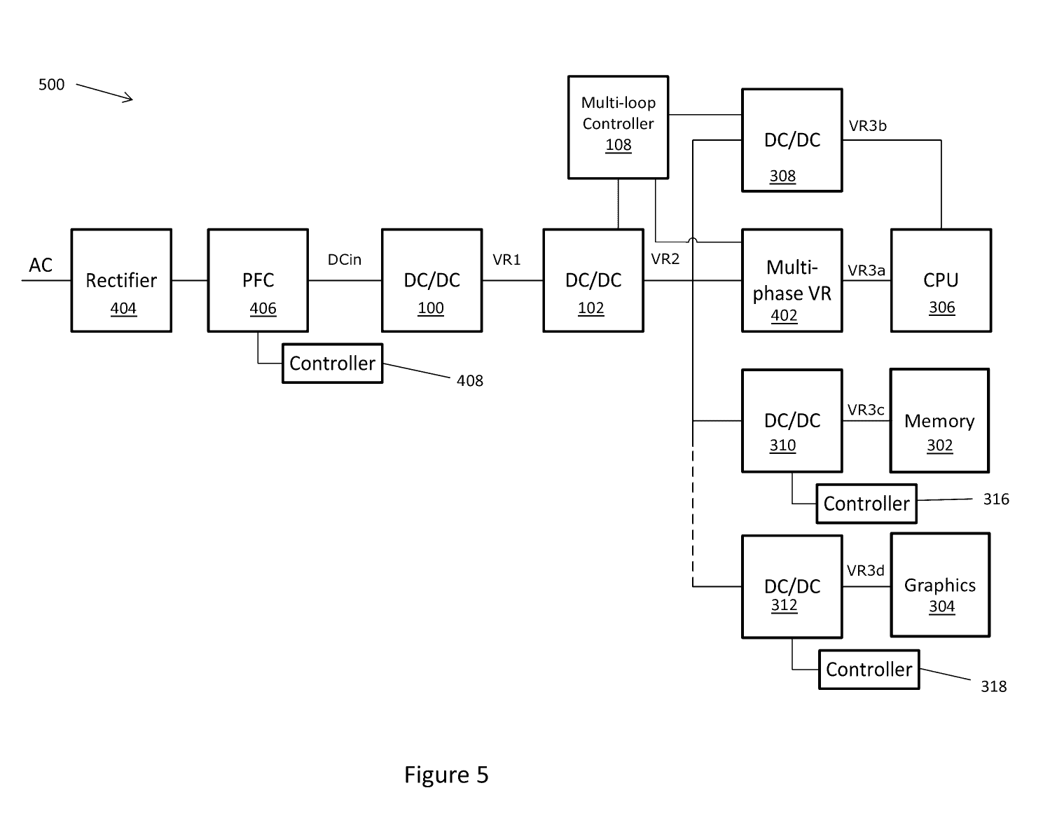

FIG. 5 shows another embodiment of a server 500 which is an extension of FIG. 2, but with two control loops 110 of the controller 108 used for both CPU power rails VR3a, VR3b and a third control loop 110 of the controller 108 powering the intermediate bus (IB) converter 102. The control loop 110 of the controller 108 used for the IB converter 102 has access to the power state registers of the first two control loops 110 and can adjust its operating point to maintain high system efficiency without sacrificing performance, as previously described herein.

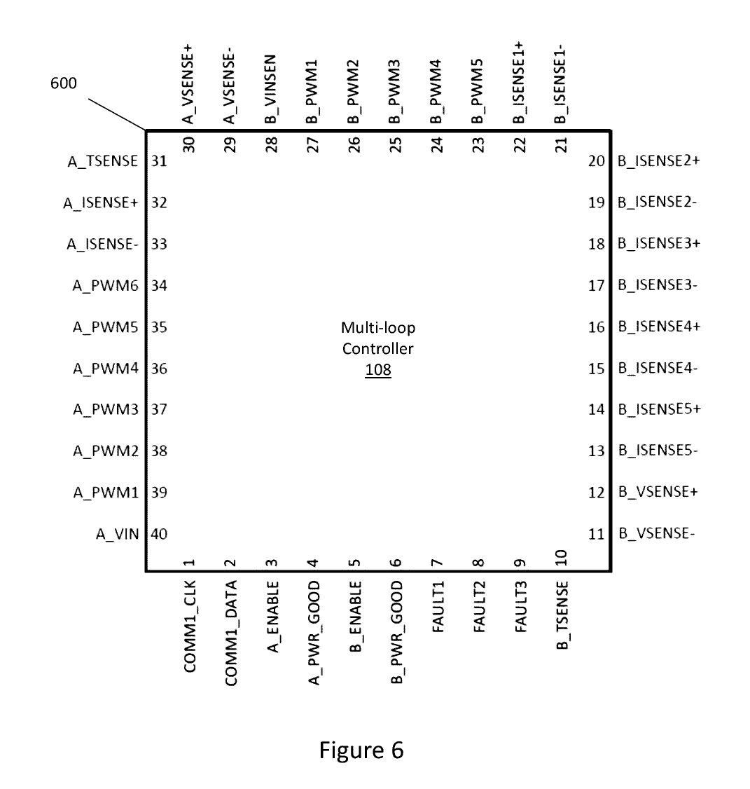

FIG. 6 illustrates an embodiment of the multi-loop controller 108 described herein, implemented as a single semiconductor die (chip) 600. The controller die 600 can be disposed in a single package.

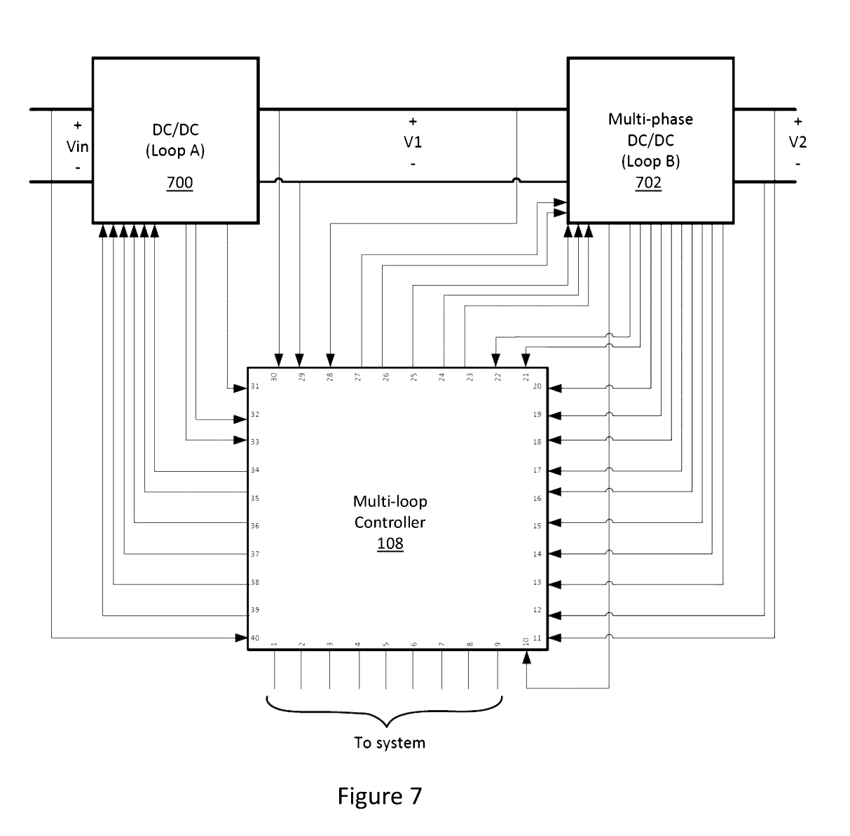

FIG. 7 illustrates the multi-loop controller 108 in communication with two voltage converters 700, 702 of a DC/DC voltage conversion system. One of the voltage converters 702 is a multiphase converter e.g. a multiphase voltage regulator as previously described herein. One loop (loop B′) of the controller 108 is a multi-phase control loop used to control operation of the multiphase converter 702. The first voltage converter 700 can be a single-phase or multiphase converter of an isolated or non-isolated topology. In either case, an additional control loop (loop A′) of the controller 108 is used to control operation of the first voltage converter 700.

An exemplary pinout for the controller 108 is shown in FIGS. 6 and 7. Two pins (COMM1_CLK, COMM1_DATA) are provided for communication, however, more than two pins for communication can be used. Fault pins (FAULT1, FAULT2, FAULT3) are also provided for indicating a fault at the controller. Each loop (A, B) receives an enable signal (A_ENABLE and B_ENABLE) and can indicate achieving regulation through their respective PWR_GOOD signals. Output voltage is sensed for each loop (VSENSE+, VSENSE−), as is temperature (TSENSE). Gating signals for each loop (PWMx) correspond to gate signals fed to drivers in either loop. Their firing sequence and timing is dependent on the topology being used and the operating point of the converter. Differential output current sense (ISENSE+, ISENSE−) is shown for a single phase of Loop A and five phases of Loop B in this implementation. Input voltage is sensed for Loop A (A_VIN); and the controller can be configured to use the same measurement for Loop B, or use the output voltage of Loop A (A_VSENSE+-A_VSENSE−) as the input voltage of Loop B in the case of cascaded converters. The number of loops supported, phases per loop and/or topologies supported are limited only by the pins on the package; not the functionality of the silicon die which includes the controller 108.

The arrows shown in FIG. 7 indicate the direction of the signals between the controller 108 and the voltage converters 700, 702 when the controller 600 is placed in the system. The first voltage converter 700 controlled by the multi-loop controller 108 converts a DC input voltage rail (Vin) to an intermediate DC voltage rail (V1) which is different than the DC input voltage rail. The multiphase voltage regulator 702 also controlled by the same multi-loop controller 108 converts the intermediate DC voltage rail V1 to a different DC voltage rail (V2) which is lower than the DC voltage rail V1. The DC voltage rail V2 can be a second intermediate DC voltage rail or a DC voltage rail applied to a load such as a CPU.

According to the embodiments described herein, different combinations of rails and power levels in different system architectures can be controlled without compromising the ability to control a multiphase converter such as a multiphase voltage regulator.

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

It is to be understood that the features of the various embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A DC/DC voltage conversion system, comprising:
a first voltage converter operable to convert a first DC voltage rail to a second DC voltage rail different than the first DC voltage rail;
a second voltage converter operable to convert the second DC voltage rail to a third DC voltage rail lower than the second DC voltage rail, wherein the second voltage converter is a multiphase converter comprising a plurality of power stages, each power stage providing a phase of the multiphase converter and configured to conduct current; and
a controller comprising a first control loop for controlling the first voltage converter and a second control loop for controlling the second voltage converter, wherein the second control loop is a multiphase control loop configured to enable multiphase operation of the second voltage converter.

2. The DC/DC voltage conversion system of claim 1, wherein the second voltage converter is a multiphase voltage regulator operable to deliver current to a load at the third DC voltage rail.

3. The DC/DC voltage conversion system of claim 1, wherein the second control loop is configured to balance the current conducted by the phases so that each phase conducts approximately the same amount of current during multiphase operation of the second voltage converter.

4. The DC/DC voltage conversion system of claim 1, wherein the power stages of the second voltage converter are paralleled between the third DC voltage rail and a load.

5. The DC/DC voltage conversion system of claim 4, wherein the load is a CPU (central processing unit), wherein the controller is operable to communicate with the CPU, and wherein the second control loop of the controller is operable to adjust operation of the second voltage converter responsive to changes communicated by the CPU.

6. The DC/DC voltage conversion system of claim 4, wherein the second control loop of the controller is operable to turn on or off different ones of the phases so that only the phases required to power the load are enabled.

7. The DC/DC voltage conversion system of claim 4, wherein the second control loop of the controller is operable to turn off all of the phases but one and operate the one phase which remains on in PFM (pulse frequency modulation) mode during light-load operation of the load.

8. The DC/DC voltage conversion system of claim 4, wherein the second control loop of the controller is operable to respond to a dynamic voltage transition at the load from a first voltage to a second voltage.

9. The DC/DC voltage conversion system of claim 4, further comprising:
a third voltage converter operable to convert the second DC voltage rail to a fourth DC voltage rail lower than the second DC voltage rail, wherein the controller comprises a third control loop for controlling the third voltage converter.

10. The DC/DC voltage conversion system of claim 1, wherein the controller comprises registers for storing state information for the second control loop, and wherein the first control loop is operable to utilize the state information for the second control loop in controlling the first voltage converter.

11. The DC/DC voltage conversion system of claim 1, wherein the first DC voltage rail is at 48V, wherein the second DC voltage rail is at 12V, and wherein the third DC voltage rail is at one of 5V, 3.3V or 1V.

12. The DC/DC voltage conversion system of claim 1, wherein the first voltage converter is an additional multiphase converter comprising a plurality of power stages, each power stage providing a phase of the additional multiphase converter which is configured to conduct current, wherein the first control loop is a multiphase control loop configured to enable multiphase operation of the first voltage converter.

13. The DC/DC voltage conversion system of claim 12, wherein the first DC voltage rail is at 48V, and wherein the second DC voltage rail is at 12V.

14. A server, comprising:
a central processing unit (CPU);
memory coupled to the CPU;
a DC/DC voltage converter for powering the CPU and the memory; and
a DC voltage distribution bus coupled to the DC/DC voltage converter,
wherein the DC/DC voltage converter comprises:
a first voltage converter operable to convert a first DC voltage rail provided by the DC voltage distribution bus to a second DC voltage rail different than the first DC voltage rail;
a second voltage converter operable to convert the second DC voltage rail to a third DC voltage rail provided by the DC voltage distribution bus and which is lower than the second DC voltage rail, wherein the second voltage converter is a multiphase voltage regulator comprising a plurality of power stages, each power stage providing a phase of the multiphase voltage regulator and configured to deliver current to the CPU; and
a controller comprising a first control loop for controlling the first voltage converter and a second control loop for controlling the second voltage converter, wherein the second control loop is a multiphase control loop configured to enable multiphase operation of the second voltage converter.

15. The server of claim 14, wherein the controller is operable to communicate with the CPU, and wherein the second control loop of the controller is operable to adjust operation of the second voltage converter responsive to changes communicated by the CPU.

16. The server of claim 14, wherein the second control loop is configured to balance the current conducted by the phases so that each phase delivers approximately the same amount of current to the CPU during multiphase operation of the second voltage converter.

17. The server of claim 14, wherein the second control loop of the controller is operable to turn on or off different ones of the phases so that only the phases required to power the CPU are enabled.

18. The server of claim 14, wherein the second control loop of the controller is operable to turn off all of the phases but one and operate the one phase which remains on in PFM (pulse frequency modulation) mode during light-load operation of the CPU.

19. The server of claim 14, wherein the second control loop of the controller is operable to respond to a dynamic voltage transition at the CPU from a first voltage to a second voltage.

20. The server of claim 14, further comprising:
a third voltage converter operable to convert the second DC voltage rail to a fourth DC voltage rail provided by the DC voltage distribution bus and which is lower than the second DC voltage rail,
wherein the controller comprises a third control loop for controlling the third voltage converter.

21. The server of claim 14, wherein the controller comprises registers for storing state information for the second control loop, and wherein the first control loop is operable to utilize the state information for the second control loop in controlling the first voltage converter.

22. The server of claim 14, wherein the first voltage converter is a multiphase converter comprising a plurality of power stages, each power stage providing a phase of the multiphase converter which is configured to conduct current, wherein the first control loop is a multiphase control loop configured to enable multiphase operation of the first voltage converter.
